(19) United States
(12) Patent Application Publication
(10) Pub. No.: US 2016/0132873 A1
(43) Pub. Date: May 12, 2016

(54) SECURE DATA ENTRY AND DISPLAY FOR A COMMUNICATION DEVICE

(71) Applicant: POINT OF PAY PTY LTD, Oakleigh (AU)

(72) Inventors: Hector Daniel Elbaum, Muurmbeena (AU); Nicholas Hardie Croucher, East Geelong (AU)

(21) Appl. No.: 14/898,338

(22) PCT Filed: Jun. 13, 2014
(86) PCT No.: PCT/AU2014/000609

§ 371 Date: Dec. 14, 2015

(30) Foreign Application Priority Data
Jun. 14, 2013 (AU) 2013902144

(51) Int. Cl. G06Q 20/38; G06Q 20/32; G06Q 20/10; G06Q 20/40

(52) U.S. Cl. CPC G06Q 20/3829; G06Q 20/401; G06Q 20/325; G06Q 20/322; G06Q 20/10

(57) ABSTRACT

The present invention is a secure transaction apparatus for use with, arid that interacts with, a mobile communication device and a remote secure transaction sewer. A transaction can be initiated by the use of the mobile communications device, and subsequently completed using the secure transaction apparatus. The secure transaction apparatus is capable of receiving and sending data via secure wireless communications protocols to the secure transaction server, and the secure transaction apparatus is capable of displaying data to a user of the transaction apparatus via a secure screen element. The secure transaction apparatus includes means to interact with the remote transaction server so that a secure and trustworthy transaction can occur.

### FIELD OF THE INVENTION

This invention relates to an apparatus and method of making a remote secure transaction using a portable communication device such as a mobile phone or a tablet computer.

### BACKGROUND OF THE INVENTION

Electronic commerce is continuing to experience exponential growth around the world. Electronic commerce now accounts for billions of dollars in sales for a wide range of goods and services.

With such vast amounts of money involved, it has become a lucrative target for criminals to use a large variety of schemes to try and defraud customers and businesses for their own financial gain.

In parallel with this is the significant increase in ownership of portable mobile communication devices such as mobile phones and tablet form factor computers. Many people have access to one of these at most times. Due to their ready availability, and also due to the fact that they are rapidly growing in utility and capability, these devices are being used more and more in commerce to search for goods and services, and to initiate and complete the payment transaction between the merchant and the customer.

Some of the most common ways in which criminals can try and defraud a customer or merchant is via a so-called “phishing” or “spoofed” website. In this type of fraudulent activity, the criminal sets up a fake website that looks and feels often exactly like the genuine website. The unsuspecting customer then lands on this spoofed website with their internet browser and does not realise that the site is not the correct one that belongs to the actual merchant they are interesting in doing business with. The unsuspecting customer may then enter into a transaction for goods and services through that fraudulent website, and then realise, often too late, that they have been defrauded.

Another problem is associated with the prevalence of applications (commonly referred to as apps) for mobile communication devices that may look and feel like an app from a genuine merchant, when in fact it is not an approved app from the merchant, and instead sets out to defraud the user of funds or confidential information such as bank account or credit card details.

It is an object of the present invention to mitigate at least some of these problems.

### SUMMARY OF THE INVENTION

Accordingly, the present invention is a secure transaction apparatus for use with, and that interacts with, a mobile communication device and a remote secure transaction server. A transaction can be initiated by the use of the mobile communications device, and subsequently completed using the secure transaction apparatus. The secure transaction apparatus is capable of receiving and sending data via secure wireless communications protocols to the secure transaction server, and the secure transaction apparatus is capable of displaying data securely to a user of the transaction apparatus via a secure screen element, thereby permitting the user to receive secure transactional information from the remote transaction server. The secure transaction apparatus includes means to acknowledge, input and send secure responses to the remote transaction server so that a secure and trustworthy transaction can occur.

Preferably the interaction between the secure transaction apparatus, the mobile communication device, and the remote transaction server, is controlled by an application installed on the mobile communication device, or included as a function within the mobile communication device's operating system software.

Preferably the secure transaction device includes a secure screen element for displaying information relating to the current transaction.

Preferably the secure screen element is a touch enabled screen thereby allowing a user of the secure transaction device to complete the transaction via touch inputs directly upon the secure screen element.

Alternatively, the secure screen element is a non-touch enabled screen, and a separate secure keypad is provided to enable a user of the secure transaction device to complete the transaction via inputs directly upon the keypad.

Preferably at least a portion of the secure transaction apparatus is attachable to the mobile communication device.

Preferably the attachable portion of the secure transaction apparatus is releasably attachable to the rear face of the mobile communication device.

Preferably the attachable portion of the secure transaction apparatus substitutes for the original rear mobile interactive device cover.

Preferably the attachable portion of the secure transaction apparatus includes means to interengage with the original battery that was supplied with the mobile communication device so that the device battery also provides the necessary power supply to the secure transaction apparatus.

Alternatively a substitute battery is provided that is capable of replacing the original battery that was supplied with the device, and the said substitute battery is capable of both providing the device with its power supply requirements, and the substitute battery includes additional power connectors that interengage with the attachable portion of the secure transaction apparatus to additionally provide the secure transaction apparatus with its power supply requirements.

Preferably the attachable portion of the secure transaction apparatus is a rear portion, and the secure transaction apparatus includes a front portion that is hingedly connected to the rear portion, and when the secure transaction apparatus is attached to the mobile communication device, the hinge is located at one side of the mobile communications device, and the front portion is able to bend around the hinge, thereby allowing the front portion to substantially overlay the front of the mobile communication device when the secure transaction apparatus and the mobile communication device is not in use.

Preferably the apparatus includes at least one physically and logically secure cryptographic module that provides the means for secure cryptographic communication between the secure transaction apparatus and the remote secure transaction server.

Preferably the application that is installed on the mobile communication device controls the interaction between the secure transaction device and the mobile communication device.

Optionally, the application provides the keypad functionality on the main display screen of the mobile communication device for the secure transaction device, and information pertaining to the secure transaction are displayed upon the secure screen element on the transaction apparatus.

A method of conducting a secure transaction via a mobile communication device using the secure transaction apparatus as previously described will now be described. The method includes the following steps wherein:
a) the user browses the world wide web on their mobile communication device and locates a website that offers goods and/or services that the user wishes to enter into a secure transaction with, and
b) the user then interacts with the website via the browser to prepare for the secure transaction, and
c) once the transaction gets to the stage where a secure exchange of information needs to occur, then either the secure transaction server of the merchant or service provider, sends a transaction initiation file directly to the handset, or alternatively to a remote transaction server, and then subsequently the remote transaction server contacts the handset, and
d) once the handset is contacted, the application that is installed on the mobile communication device is initiated, and the application then activates the secure transaction apparatus and hands over the remaining steps of the transaction to the secure transaction apparatus, and
e) then in the case of an interaction with a merchant, the secure transaction apparatus then queries the remote transaction server, to determine the bona fides of the merchant and the details of the payment transaction, and
f) if the bona fides of the merchant are verified by the remote secure transaction server, the secure transaction apparatus then causes the details pertaining to the transaction to be displayed on the secure screen element, and the user is then prompted to complete their transaction by interacting directly via the secure screen element and its associated keypad if is applicable, and
g) the user is then prompted to confirm the transaction, and
h) the secure transaction apparatus then retrieves all available payment types that may be pre-stored securely in the mobile communication device by the user, and the secure transaction apparatus then offers the user a menu list of payment type(s), or the user is presented with an option to use an unstored payment option, and
i) the secure transaction apparatus then sends a prompt to the user to select a payment type, and
j) then once the payment type is selected, the secure transaction apparatus then prompts the user to enter their security credentials for that particular payment type, such as a PIN or other kind of signature that is pre-associated with the selected payment type, and
k) the user then enters the associated PIN via the secure screen element's associated keypad, or they may be prompted to enter their signature using their finger or a stylus on the secure screen element, and
l) finally the required payment type data and its associated PIN or signature is then sent via the secure transaction apparatus to the payment processing system for the selected payment type.

Preferably the mobile communication device is a mobile phone, portable computer or tablet computer.

In another preferred embodiment, at least the secure screen element is incorporated in the rear of the main body of the phone and is thereby non-detachable.

In another preferred embodiment of the invention, the secure electronic device and its associated software is incorporated directly into the electronics and system software respectively of the mobile communication device by the manufacturer at time of construction of the device.

In another preferred embodiment, the secure auxiliary interactive display screen is at least partially incorporated into the main display screen of the communication device so that when in use, at least a portion of the main display screen provides a secure display portion and data input region on the main display of the mobile communication device.

Preferably the secure auxiliary interactive display screen is incorporated into the main display screen of the device, the display of the secure auxiliary interactive display screen is seamlessly integrated into the display shown on the main display screen of the mobile communication device when the secure auxiliary interactive display screen is not in use.

It should be noted that for the purposes of this invention disclosure, the use of the term “transacation” includes all kinds of transactions, including, but not limited to, financial transactions and secure authorisations, and the entry and editing of secure information, such as medical details, or education enrollment details.

### BRIEF DESCRIPTION OF THE DRAWINGS

FIG. 1 shows an exploded isometric view of a mobile communication device about to be fitted with a secure transaction apparatus according to the present invention.

FIG. 2 shows an isometric rear view of a mobile communication device being fitted with a preferred embodiment of the secure transaction device, and also a substitute battery with additional power supply contacts.

FIG. 3 shows an isometric view of a mobile communication device that has been fitted with a preferred embodiment of secure transaction apparatus according to the present invention.

FIG. 4 illustrates the interaction of the service provider, the remote secure transaction server and the secure transaction apparatus in accordance with the present invention.

### DESCRIPTION OF EXAMPLES OF THE INVENTION AND THE PREFERRED EMBODIMENT

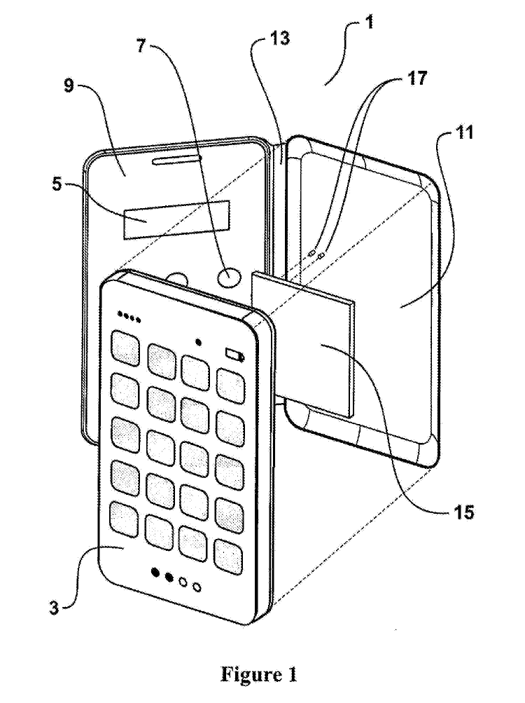

Turning firstly to FIG. 1, we see a preferred embodiment of the secure transaction apparatus 1. In this figure, the mobile communication device 3 is a mobile phone. The rear cover of the mobile phone 3 has been removed, and the rear portion 11 of the secure transaction apparatus 1 is custom made for that particular make and model of mobile communication device. The original cover supplied by the mobile communication device manufacturer is totally removed and substituted with the rear portion 11 of the secure transaction apparatus 1.

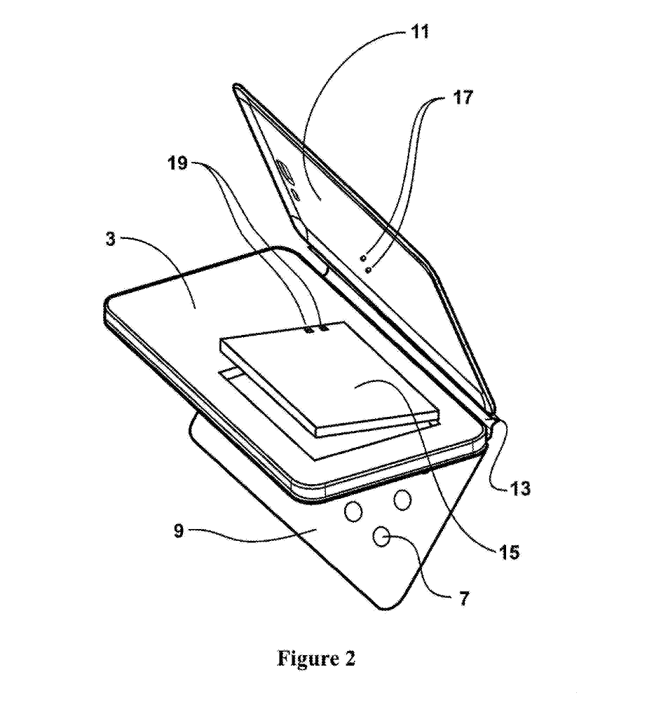

Also in this example, a substitute battery 15 is inserted. The substitute battery provides the power requirements of both the mobile communication device 3 and the secure transaction apparatus 1. The substitute battery 15 includes a pair of auxiliary battery power connectors 19 (shown in FIG. 2). When the rear portion 11 is attached to the back of the mobile communication device 3, the battery connector pins 17 make electrical contact with the auxiliary battery power connectors 19.

It can be seen in this preferred embodiment of the invention that the secure transaction apparatus 1 also includes a front portion 9 that is hingedly connected to the rear portion 11 via hinge 13. The front portion 9 includes at least a secure screen element 5 on its inside face. In this embodiment, the secure screen element 5 is not a touch enabled screen, and an associated keypad 7 is illustrated.

In another embodiment, the secure screen element 5 is fully touch interactive, so no associated keypad is required.

Turning to FIG. 2, we can now see the auxiliary battery power connectors 19 that make electrical contact with the pins 17 on the rear portion of the secure transaction apparatus 1.

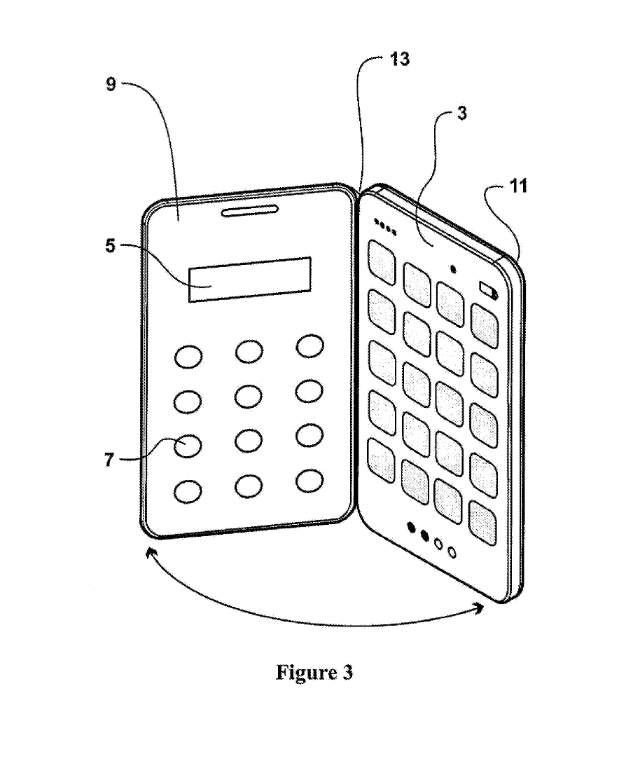

FIG. 3 illustrates how in this preferred embodiment of the invention, the front portion 9 is able to open and close upon the front face of the mobile communication device 3. When the device 3 and apparatus 1 are not in use, the front portion 9 can overlay the front face of the mobile communication device 3 to protect both the display of the mobile communication device 3 as well as the secure screen element 5 and keypad 7 if present.

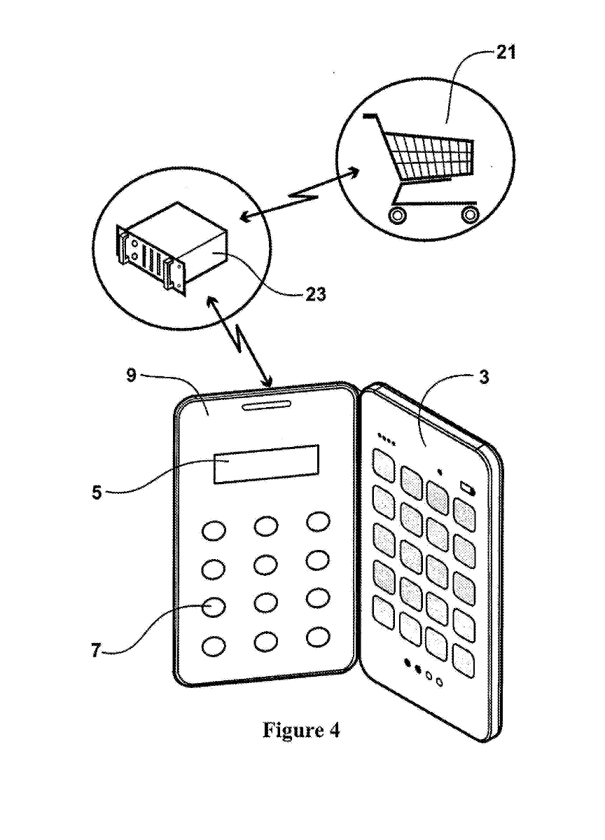

In FIG. 4 we are shown a schematic of the network that connects the secure transaction apparatus 1 to the service provider 21. To use the apparatus 1 to secure transactions, all service providers, including merchants, must first register their credentials on the secure transaction server 23.

To commence using the secure transaction apparatus 1, the user first attaches the apparatus 1 to the mobile communication device 3. The user is then prompted to install an official application on their mobile communication device, which will manage any secure transactions between the user and the service provider, via the apparatus 1.

After the apparatus and the application are installed, the user can then enter into a secure transaction with a service provider. The user first navigates to the service provider's website via a standard browser in their mobile communication device 3. As an example, if they are shopping at an online store, they first navigate to the store with their standard browser and commence shopping. The items they select are placed in their shopping cart. When they have finished selecting items from the store, they are now ready to choose a delivery option and make payment for the goods and any ancillary charges. Once their interaction with the store's website reaches the point where payment needs to be made, the service provider either then automatically sends a transaction initiation file directly to the mobile communication device 3, or alternatively, the service provider prompts the secure transaction server 23 to send the transaction initiation file to the mobile communication device 3. The receipt of the transaction initiation file on the mobile communication device 3 causes the application that has been installed on the mobile communication device 3 to become active, and commence managing the secure transaction.

The application activates the secure transaction apparatus 1, and the secure transaction apparatus 1 then contacts the secure transaction server 23 and checks the bona fides of the service provider. Once the bona fides are established, the details of the particular secure payment transaction are displayed on the secure screen element 5. The user is then prompted to confirm the transaction. The user may pre-store a variety of payment type options in the secure transaction apparatus, or alternatively the user may be presented with the option to use an unstored payment option.

Once a payment type has been chosen by the user, the user is then prompted to enter their security credentials for that particular payment type, such as a personal identification number (PIN) or a signature or password that has been pre-associated with that particular payment type. The user then enters the relevant security credentials directly into the secure transaction apparatus 1, and the transaction is completed.

In another example, the user could be prompted to write their signature either directly with their finger, or via a stylus onto a touch enabled secure screen element 5.

In another form of the invention, the secure transaction apparatus 1 and its associated secure screen element 5 may be integrated into the rear face of the mobile communication device 3.

In another embodiment, the secure screen element 5 is integrated into at least a to portion of the device's main display screen. When the auxiliary screen is not activated, it seamlessly integrates its display with the information being displayed on the main screen. When activated, it displays separate information to that which it shown on the main display.

The security electronics can be installed as part of the main electronics of the device, by the manufacturer at the time at which the device is manufactured. Alternatively there is the possibility that the security apparatus can be installed either by the manufacturer, or some other approved third party after the manufacture of the device.

Also as an alternative, the software functionality required to control the secure transaction may be integrated into, the device's operating system software, instead of requiring a separate application to be installed.

In another preferred embodiment, the secure transaction server 23 is of the type that is the subject of the inventor's corresponding patents entitled “Secure Payment System” wherein by example, the Australian patent family member is numbered 2011203165. The system utilises a gateway device connected to the public data network which is in communication with the security device on the mobile communication device, and to a private data network used for transmitting messages between financial institutions; wherein the secure data entry device includes means for the user to enter identifying information of a card issued by the card issuing financial institution, and means for transmitting the identifying information in a secure manner over the public data network to the gateway device; and wherein the gateway device includes means for transmitting the identifying information to the card-issuing financial institution and for receiving an approval response from the card-issuing financial institution over the private data network; whereby the approval response provides authentication of the identifying information by the card-issuing financial institution.

The entire goal of the present invention is to provide a trusted chain of communication links, information display and data input commands that allow secure transactional information to transfer in both directions, and that includes a secure to transaction server that is capable of determining whether the service provider is genuine or not, and that also has the capability of using a particular payment type's payment verification system to authorise and make payment to the service provider.

While the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge.

1. A secure transaction apparatus for use with, and that interacts with, a mobile communication device and a remote secure transaction server wherein a transaction can be initiated by the use of the mobile communications device, and subsequently completed using the secure transaction apparatus, and wherein said secure transaction apparatus is capable of receiving and sending data via secure wireless communications protocols to the secure transaction server, and the secure transaction apparatus is capable of displaying data securely to a user of the transaction apparatus via a secure screen element, thereby permitting the user to receive secure transactional information from the remote transaction server, and wherein the secure transaction apparatus includes means to acknowledge, input and send secure responses to the remote transaction server so that a secure and trustworthy transaction can occur.

2. A secure transaction apparatus as defined in claim 1 wherein the interaction between the secure transaction apparatus, the mobile communication device, and the remote transaction server, is controlled by a software application installed on the mobile communication device, or included as a function within the mobile communication device's operating system software.

3. A secure transaction apparatus as defined in claim 2 wherein the secure transaction device includes a secure screen element for displaying information relating to the current transaction.

4. A secure transaction apparatus as defined in claim 3 wherein the secure screen element is a touch enabled screen thereby allowing a user of the secure transaction device to complete the transaction via touch inputs directly upon the secure screen element.

5. A secure transaction apparatus as defined in claim 3 wherein the secure screen element is a non-touch enabled screen, and a separate secure keypad is provided to enable a user of the secure transaction device to complete the transaction via inputs directly upon the keypad.

6. A secure transaction apparatus as defined in either claim 4, wherein at least a portion of the secure transaction apparatus is attachable to the mobile communication device.

7. A secure transaction apparatus as defined in either claim 4, wherein the secure transaction apparatus and its associated software application is built directly into the mobile communication device hardware and its associated system software respectively, at the time of manufacture of the mobile communication device.

8. A secure transaction apparatus as defined in either claim 6, wherein the at least a portion of the secure transaction apparatus is releasably attachable to the rear of the mobile communications device.

9. A secure transaction apparatus as defined in claim 8 wherein the at least a portion of the secure transaction apparatus substitutes for the original rear mobile interactive device cover.

10. A secure transaction apparatus as defined in claim 9 wherein the at least a portion of the secure transaction apparatus includes means to interengage with the original battery that was supplied with the mobile communication device so that the device battery also provides the necessary power supply to the secure transaction apparatus.

11. A secure transaction apparatus as defined in claim 10 wherein a substitute battery is provided that is capable of replacing the original battery that was supplied with the device, and the said substitute battery is capable of both providing the device with its power supply requirements, and said substitute battery includes additional power connectors that interengage with the at least a portion of the secure transaction apparatus to additionally provide the secure transaction apparatus with its power supply requirements.

12. A secure transaction apparatus as defined in claim 10, wherein the at least a portion of the secure transaction apparatus is a rear portion, and the secure transaction apparatus includes a front portion that is hingedly connected to the rear portion, and when the secure transaction apparatus is attached to the mobile communications device, the hinge is located at one side of the mobile communications device, and the front portion is able to bend around the hinge, thereby allowing the front portion to substantially overlay the front of the mobile communication device when the secure transaction apparatus and the mobile communication device is not in use.

13. A secure transaction apparatus as defined in claim 12 wherein the apparatus includes at least one physically and logically secure cryptographic module that provides the means for secure, cryptographic communication between the secure transaction apparatus and the remote secure transaction server.

14. A secure transaction apparatus as defined in claim 13 wherein the software application installed on the mobile communication device controls the interaction between the secure transaction device and the mobile communication device, the application provides the keypad functionality on the main display screen of the mobile communication device, and information pertaining to the secure transaction are displayed upon the secure screen element on the transaction apparatus.

15. A method of conducting a secure transaction via a mobile communication device using the secure transaction apparatus as previously defined, including the following steps wherein:
a) the user browses the world wide web on their mobile communication device and locates a website that offers goods and/or services that the user wishes to enter into a secure transaction with, and
b) the user then interacts with the website via the browser to prepare for the secure transaction, and
c) once the transaction gets to the stage where a secure exchange of information needs to occur, then either the secure transaction server of the merchant or service provider, sends a transaction initiation file directly to the handset, or alternatively to a remote transaction server, and then subsequently the remote transaction server contacts the handset, and
d) once the handset is contacted, the application that is installed on the mobile communication device is initiated, and the application then activates the secure transaction apparatus and hands over the remaining steps of the transaction to the secure transaction apparatus, and
e) then in the case of an interaction with a merchant, the secure transaction apparatus then queries the remote transaction server, to determine the bona fides of the merchant and the details of the payment transaction, and
f) if the bona fides of the merchant are verified by the remote secure transaction server, the secure transaction apparatus then causes the details pertaining to the transaction to be displayed on the secure screen element, and the user is then prompted to complete their transaction by interacting directly via the secure screen element and its associated keypad if applicable, and
g) the user is then prompted to confirm the transaction, and
h) the secure transaction apparatus then retrieves all available payment types that may be pre-stored securely in the mobile communication device by the user, and the secure transaction apparatus then offers the user a menu list of payment type(s), or the user is presented with an option to use an unstored payment option, and
i) the secure transaction apparatus then sends a prompt to the user to select a payment type, and
j) then once the payment type is selected, the secure transaction apparatus then prompts the user to enter their security credentials for that particular payment type, such as a PIN or other kind of signature that is pre-associated with the selected payment type, and
k) the user then enters the associated PIN via the secure screen element's associated keypad, or they may be prompted to enter their signature using their finger or a stylus on the secure screen element, and
l) finally the required payment type data and its associated PIN or signature is then sent via the secure transaction apparatus to the payment processing system for the selected payment type.

16. The secure transaction apparatus of claim 5, wherein at least a portion of the secure transaction apparatus is attachable to the mobile communication device.

17. The secure transaction apparatus of claim 5, wherein the secure transaction apparatus and its associated software application is built directly into the mobile communication device hardware and its associated system software respectively, at the time of manufacture of the mobile communication device.

18. The secure transaction apparatus of claim 11, wherein the at least a portion of the secure transaction apparatus is a rear portion, and the secure transaction apparatus includes a front portion that is hingedly connected to the rear portion, and when the secure transaction apparatus is attached to the mobile communications device, the hinge is located at one side of the mobile communications device, and the front portion is able to bend around the hinge, thereby allowing the front portion to substantially overlay the front of the mobile communication device when the secure transaction apparatus and the mobile communication device is not in use.
